(19) United States
(12) Patent Application Publication
(10) Pub. No.: US 2018/0347646 A1
(43) Pub. Date: Dec. 6, 2018

(54) ACTUATION OF A CLUTCH OF A MOTOR VEHICLE

(71) Applicant: GM GLOBAL TECHNOLOGY OPERATIONS LLC, Detroit, MI (US)

(72) Inventor: Florian Dietsch, Koeln (DE)

(73) Assignee: GM GLOBAL TECHNOLOGY OPERATIONS LLC, Detroit, MI (US)

(21) Appl. No.: 15/995,228

(22) Filed: Jun. 1, 2018

(30) Foreign Application Priority Data
Jun. 1, 2017 (DE) 102017005230.1

(51) Int. Cl. F16D 48/06; F16D 27/00

(52) U.S. Cl. CPC F16D 48/064; F16D 27/00; F16D 2500/3128; F16D 2500/30412; F16D 2500/1021

(57) ABSTRACT

A control device and method are configured to actuate a clutch between a drive unit and at least one driven wheel of a motor vehicle, particularly a passenger car. The control device at least partially engages the clutch differently in dependence on a distance of the motor vehicle from an environment and/or a change of this distance.

### CROSS-REFERENCE TO RELATED APPLICATION

This application claims priority to German Patent Application No. 102017005230.1, filed Jun. 1, 2017, which is incorporated herein by reference in its entirety.

### TECHNICAL FIELD

The present disclosure pertains to a method and a control device for actuating a clutch between a drive unit and at least one driven wheel of a motor vehicle, to a motor vehicle, particularly a passenger car, with such a control device, as well as to a computer program product for carrying out the method.

### BACKGROUND

It is generally known to actuate a clutch of a motor vehicle with an electrically-actuated control device. This makes it possible to electrically implement a sensor-detected actuation of a clutch pedal or even to eliminate the clutch pedal and engage the clutch in an automated fashion in order to put the vehicle in motion or to shift gears of a gearbox, for example to at least partially shift a manual gearbox.

In addition, an electric actuation of the clutch makes it possible to park the motor vehicle in an at least partially automated fashion or to facilitate a manual parking maneuver. However, different engagement characteristics of the clutch may be desirable in this case.

For example, it may be particularly advantageous or desirable to engage the clutch more quickly in order to respectively start a driving mode or normally put the vehicle in motion, e.g. at a traffic light, and to thereby rapidly accelerate the motor vehicle to a traveling speed.

On the other hand, it may also be advantageous or desirable to engage the clutch more slowly and/or incompletely, particularly during a parking maneuver, in a congested traffic or the like and/or in order to realize a crawling mode or a crawling speed of the motor vehicle, particularly in such a situation.

With conventional control devices, the engagement characteristic of the clutch realized with such control device had to represent a compromise between these different requirements or situations. Accordingly, there is a need to improve the actuation of a clutch of a motor vehicle to account for various requirements or situations.

### SUMMARY

According to an embodiment of the present disclosure, a control device for actuating a clutch between a drive unit and one or more driving or driven wheels of a motor vehicle, particularly a passenger car, completely or partially engages or is configured for completely or partially engaging differently (in different ways) depending or based on the distance of the motor vehicle, particularly its determined and/or minimal distance, from an environment, particularly a limited or defined environment, particularly one or more obstacles, particularly nearest and/or detected obstacles in the environment, particularly in front of and/or behind the vehicle, and/or depending or based on a change, particularly a time rate of change, particularly a first and/or higher time derivative, of this distance.

In an embodiment, the clutch can be engaged differently depending on the respective situation, particularly more quickly in order to respectively start a driving mode or normally put the vehicle in motion, e.g. at a traffic light, and to thereby quickly accelerate the motor vehicle to a traveling speed and/or more slowly and/or incompletely during or for a parking maneuver, in congested traffic or the like and/or in order to realize a crawling mode or a crawling speed of the motor vehicle, particularly in such situations.

In an embodiment, the control device completely or partially engages the clutch with a first engagement or clutch characteristics, particularly a first clutch torque profile such as a first clutch torque curve, if the distance from an obstacle, particularly a nearest obstacle in the environment in front of and/or behind the vehicle, and/or a change, particularly a time rate of change such as a first and/or higher time derivative, of this distance has a first value. The control device completely or partially engages the clutch with a different second engagement or clutch characteristic, particularly a second clutch torque profile such as a second clutch torque curve, if this distance and/or this change has a different second value.

In an embodiment, the clutch can be engaged differently depending on the respective situation, for example more quickly at a traffic light, at which the distance from a leading vehicle increases more quickly, and/or more slowly and/or incompletely during or for a parking maneuver, during which the distance from a parking boundary is shorter and/or decreases, in order to thereby realize a crawling mode or a crawling speed of the motor vehicle.

In an embodiment, the control device engages the clutch up to a first degree of engagement or transmitted torque and/or in a first time and/or with the first torque gradient or torque buildup, particularly a maximum or average torque gradient or torque buildup, particularly a torque gradient or torque buildup over time, if the distance and/or the change has the first value. The control device engages the clutch up to a different and, in particular, greater second degree of engagement or transmittable or transmitted torque and/or in a different and, in particular, shorter second time and/or with a different and, in particular, greater second torque gradient or torque buildup, particularly a maximum or average torque gradient or torque buildup, particularly a torque gradient or torque buildup over time, if the distance and/or the change has the second and, in particular, greater value.

In an embodiment, the clutch can be engaged differently depending on the respective situation, for example completely at a traffic light, at which the distance from a leading vehicle is greater and/or increases more quickly, and/or incompletely and/or more slowly and/or with a smaller gradient during or for a parking maneuver, during which the distance from a parking boundary is shorter and/or decreases.

The engagement may particularly be dependent on only the distance, only its change or the distance and its change and the control device can at least partially engage the clutch differently in dependence thereon. For example, a leading vehicle being put in motion can be detected despite a very short distance, which predominantly occurs during parking maneuvers, based on a quickly increasing distance and the clutch can be accordingly engaged faster in order to put the vehicle in motion more quickly. Accordingly, the first and the second value may be a value for the distance, a value for a change of the distance or also a multidimensional or vector-based value for the distance and the change.

In an embodiment, the distance and/or the change is determined and one of multiple engagement or clutch characteristics, particularly empirical characteristics and/or characteristics defined by a characteristic diagram, particularly stored characteristics, is assigned to the determined distance or the determined change. The control device then at least partially engages the clutch or activates or commands an actuator for engaging the clutch with the assigned characteristic.

In an embodiment, the clutch can be engaged differently depending on the respective situation, for example by implementing or using an engagement or a clutch characteristic for putting the vehicle in motion more quickly, e.g. if the environment in front of the vehicle is clear, an engagement or clutch characteristic for putting the vehicle in motion more slowly, e.g. at a traffic light, or an engagement or clutch characteristic for realizing a crawling mode, particularly during a parking maneuver, in dependence on the determined distance or the determined change.

In an embodiment, the control device at least partially engages the clutch differently depending or based on an actuation of an actuator such as an accelerator pedal, a brake pedal or a clutch pedal, and/or a speed of the motor vehicle and/or a change of this speed. In an enhancement, the control device engages or is configured for engaging the clutch, particularly at the same distance and/or the same change of the distance, up to a degree of engagement or transmitted torque and/or in a time and/or with a torque gradient or torque buildup, particularly a maximum or average torque gradient or torque buildup, particularly a torque gradient or torque buildup over time, if a first actuation of the actuator is detected and/or the speed and/or its change has a value, wherein the control device engages or is configured for engaging the clutch up to a different degree of engagement or transmittable or transmitted torque and/or in a different time and/or with a different torque gradient or torque buildup, particularly a maximum or average torque gradient or torque buildup, particularly a torque gradient or torque buildup over time, if a different second actuation of the actuator is detected and/or the speed and/or its change has a different value.

In an embodiment, the engagement of the clutch can be advantageously adapted to different vehicle states and/or driver requests. For example, the clutch can be engaged more quickly in a faster moving vehicle and/or when an accelerator pedal is actuated.

In an embodiment, the control device at least partially engages the clutch in dependence on the distance and/or its change differently in one or more driving start modes for starting a regular driving mode or accelerating the vehicle to a traveling speed and/or in one or more parking modes, particularly completely or partially automated parking modes, particularly for realizing a crawling speed of the vehicle.

As already mentioned above, different engagement or clutch characteristics can be made available or used or commanded or realized in an embodiment, particularly for normally putting the vehicle in motion or for realizing a crawling mode.

In an embodiment, the distance of the motor vehicle, particularly its minimal distance, from the environment, particularly a defined environment, particularly one or more obstacles, particularly nearest obstacles in the environment in front of and/or behind the vehicle, and/or the change of this distance is determined by a sensor arrangement with one or more environment sensors, particularly vehicle-mounted and/or contactless measuring sensors. The sensor arrangement includes in an enhancement one or more driver assistance and/or parking sensors, one or more cameras and/or one or more radar sensors, particularly for parking maneuvers, one or more front sensors, particularly driver assistance and/or parking sensors, cameras or radar sensors, and/or one or more rear sensors, particularly driver assistance and/or parking sensors, cameras or radar sensors.

Due to the utilization of driver assistance and/or parking sensors, which are also used, in particular, for at least partially manual and/or automated parking maneuvers or driver assistance functions, these sensors can in an embodiment advantageously take on another functionality. In an embodiment, the utilization of cameras and radar sensors makes it possible to precisely and/or reliably determine the distance or its change. In an embodiment, the utilization of front sensors makes it possible to take into account a clear space in front of the vehicle or its change, particularly for accelerating the vehicle faster and for actuating the clutch accordingly if the clear space is large and/or increases. In an embodiment, the utilization of rear sensors makes it possible to take into account a clear space behind the vehicle or its change, particularly for accelerating the vehicle slower during parking maneuvers and for actuating the clutch accordingly if the clear space is small and/or decreases.

In an embodiment, the clutch is arranged between the drive unit and a shift gearbox, particularly an at least partially automatic and/or at least partially manual shift gearbox, particularly a dual-clutch gearbox. In an embodiment, the clutch additionally or alternatively is actuated or can be actuated electrically by the control device. In an embodiment, the drive unit includes at least one internal combustion engine and/or at least one electric motor. A control device in accordance with the present disclosure can be used in a particularly advantageous fashion in clutches of this type.

According to an embodiment of the present disclosure, a control device for actuating a clutch between a drive unit and at least one driven wheel of a motor vehicle, particularly a passenger car, is configured for carrying out a method described herein, particularly in the form of hardware and/or software technology, particularly program technology, and/or is configured to at least partially engage the clutch differently depending or based on the distance of the motor vehicle, particularly its determined and/or minimal distance, from an environment, particularly a defined environment, particularly one or more obstacles, particularly nearest obstacles in the environment in front of and/or behind the vehicle, and/or depending or based on a change, particularly a time rate of change, particularly a first and/or higher time derivative, of this distance, as well as for at least partially engaging the clutch in different ways in dependence on the distance and/or its change.

In an embodiment, the control device is configured to at least partially engage the clutch with a first characteristic if a distance from an obstacle and/or a change of this distance has a first value and for at least partially engaging the clutch with a different second characteristic if this distance and/or this change has a different second value.

In an embodiment, the control device is configured to engage the clutch up to a first degree of engagement and/or in a first time and/or with a first torque gradient if the distance and/or the change has the first value and for engaging the clutch up to a different and, in particular, greater second degree of engagement and/or in a different and, in particular, shorter second time and/or with a different and, in particular, greater second torque gradient, if the distance and/or the change has the second and, in particular, greater value.

In an embodiment, the control device is configured to determine the distance and/or the change and assigning one of multiple predefined characteristics, with which the control device at least partially engages the clutch.

In an embodiment, the control device is configured to at least partially engage the clutch in dependence on an actuation of an actuator and/or a speed of the motor vehicle and/or a change of this speed.

In an embodiment, the control device is configured to at least partially engage the clutch differently in dependence on the distance and/or its change in at least one driving start mode and/or at least one parking mode.

In an embodiment, the control device includes a sensor arrangement with at least one environment sensor, particularly a vehicle-mounted and/or contactless environment sensor, for determining the distance and/or the change.

In the context of the present disclosure, the control device may be at least partially realized in the form of hardware and/or software technology, particularly in the form of a digital processing unit such as a microprocessor unit (CPU), which is data-linked and signal-linked to a storage or memory system and/or a data bus, and/or include one or more programs or program modules. The CPU may be configured for processing commands that are implemented in the form of a program stored in a memory system, for acquiring input signals from the data bus and/or for delivering output signals to the data bus. A memory system may include one or more storage mediums, particularly different storage mediums, particularly optical, magnetic, solid state and/or other non-volatile mediums. The program may be realized in such a way that it embodies or is capable of carrying out the methods described herein such that the CPU can carry out the methods, particularly in order to thereby actuate a clutch or to activate or command a clutch actuator accordingly. In an embodiment, one or more steps of the method, particularly all steps, are carried out in a completely or partially automated fashion, particularly by the control device.

### BRIEF DESCRIPTION OF THE DRAWINGS

The present disclosure will hereinafter be described in conjunction with the following drawing figures, wherein like numerals denote like elements.

FIG. 1 shows a motor vehicle with a control device for actuating a clutch according to an embodiment of the present disclosure; and

FIG. 2 shows a method for actuating the clutch according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

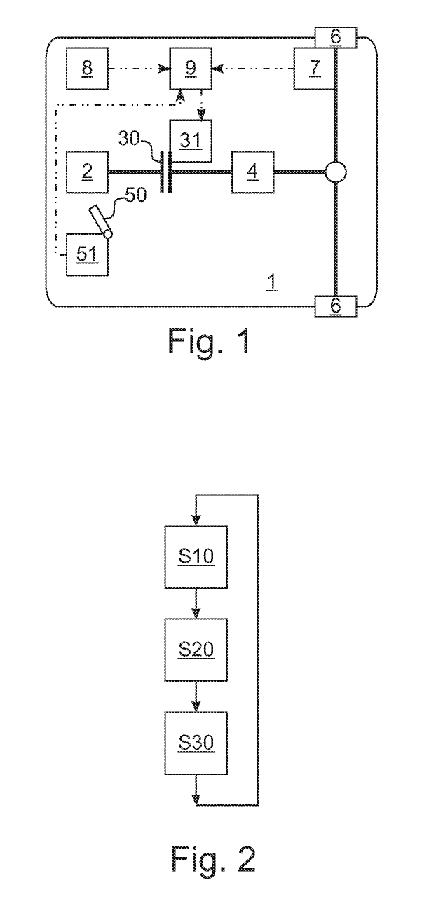

FIG. 1 shows a motor vehicle 1 with a control device 9 for actuating a clutch 30 according to an embodiment of the present disclosure and FIG. 2 shows a corresponding method carried out by the control device 9.

The motor vehicle 1 includes a drive unit, particularly at least one internal combustion engine and/or at least one electric motor 2, which drives or is configured for driving driven wheels 6 via the (at least partially automatic) clutch 30 and a shift gearbox 4, particularly an at least partially manual and/or at least partially automatic shift gearbox.

An accelerator pedal sensor 51 detects a position or actuation of the accelerator pedal 50 and transmits this position or actuation to the control device 9. A speed sensor 7 detects a vehicle speed and likewise transmits this vehicle speed to the control device 9.

A sensor arrangement 8 with at least one sensor, particularly at least one front and/or at least one rear sensor, such as a camera and/or a radar sensor, detects a minimal distance from an obstacle nearest the vehicle in the environment in front or behind the vehicle and transmits this minimal distance to the control device 9 that, if applicable, determines its time rate of change accordingly. The control device 9 actuates the clutch 30 electrically in that or wherein it correspondingly actuates or commands an actuator 31 for disengaging and engaging the clutch 30.

With reference to FIG. 2 in combination with FIG. 1, at S10, it is detected that the clutch 30 should be engaged, for example, due to the engagement of a gear of the gearbox 4 by the driver or a corresponding command. At S20, the current distance and/or its change detected by the sensor arrangement 8, the current position or actuation of the accelerator pedal 50 detected by the sensor 51 and the current vehicle speed detected by the sensor 7 are assigned to one or more different clutch torque curves with the aid of a characteristic diagram.

At S30, the control device 9 engages the clutch 30 in accordance with this clutch torque curve by correspondingly actuating or commanding the actuator 31, for example more quickly and/or completely if the sensor arrangement 8 detects that a clear space, particularly in front of the vehicle, is large or increases, particularly increases more quickly, and/or more slowly and/or only partially if the sensor 8 detects that a clear space in front of the vehicle is small or decreases.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-12. (canceled)

13. A method for actuating a clutch operatively arranged between a drive unit and at least one driven wheel of a motor vehicle comprising:
determining a distance parameter for the motor vehicle, wherein the distance parameter is selected from a group of parameters consisting of a distance between the motor vehicle and an object in an environment of the motor vehicle, a change in the distance, a first time derivative of the change in the distance, a second time derivative of the change in the distance or a combination thereof; and
at least partially engaging the clutch with a control device according to a clutch torque curve as a function of the distance parameter.

14. The method according to claim 13 further comprising assigning the clutch torque curve at least one predefined characteristic with which the control device at least partially engages the clutch, wherein the at least one predefined characteristic is selected from the group consisting of a degree of clutch engagement, a time of clutch engagement, a torque gradient or a combination thereof.

15. The method according to claim 13 further comprising:
at least partially engaging the clutch with the control device according to a first characteristic when the distance parameter has a first value; and
at least partially engaging the clutch with the control device according to a second clutch torque curve when the distance parameter has a second value, wherein the second clutch torque curve and the second value are different from the first clutch torque curve and the first value respectively.

16. The method according to claim 16 further comprising assigning each of the first and second clutch torque curves at least one predefined characteristic with which the control device at least partially engages the clutch, wherein the at least one predefined characteristic is selected from the group consisting of a degree of clutch engagement, a time of clutch engagement, a torque gradient or a combination thereof.

17. The method according to claim 13 further comprising:
determining an actuation parameter for an actuator of the motor vehicle;
at least partially engaging the clutch with the control device as a function of the distance parameter and the actuation parameter.

18. The method according to claim 13 further comprising:
determining an operating mode of the vehicle; and
at least partially engaging the clutch with the control device as a function of the distance parameter and the operating mode.

19. The method according to claim 20, wherein the operating mode is selected from the group consisting of a driving start mode or a parking mode.

20. The method according to claim 13, wherein determining the distance parameter for the motor vehicle comprises:
sensing a distance between the motor vehicle and an object in an environment around the motor vehicle with a sensor arrangement; and
computing the distance parameter from the sensed distance.

21. The method according to claim 22, wherein the sensor arrangement is selected from the group consisting of a driver assistance sensor, a parking sensor, a camera, a radar sensor, a front sensor, a rear sensor or a combination thereof.

22. A control device comprising an actuator and a controller actuating a clutch to selectively couple a drive unit and a driven wheel, wherein the controller is configured to:
determine a distance parameter for the motor vehicle, wherein the distance parameter is selected from a group of parameters consisting of a distance between the motor vehicle and an object in an environment of the motor vehicle, a change in the distance, a first time derivative of the change in the distance, a second time derivative of the change in the distance or a combination thereof;
determine a clutch torque curve as a function of the distance parameter; and
control the actuator for at least partially engaging the clutch according to the clutch torque curve.

23. The control device according to claim 24, wherein the controller is further configured to:
control the actuator for at least partially engaging the clutch with the control device according to a first characteristic when the distance parameter has a first value; and
control the actuator for at least partially engaging the clutch with the control device according to a second clutch torque curve when the distance parameter has a second value, wherein the second clutch torque curve and the second value are different from the first clutch torque curve and the first value respectively.

24. The control device according to claim 25, wherein the controller is further configured to assigning each of the first and second clutch torque curves at least one predefined characteristic with which the control device at least partially engages the clutch, wherein the at least one predefined characteristic is selected from the group consisting of a degree of clutch engagement, a time of clutch engagement, a torque gradient or a combination thereof.

25. The control device according to claim 24, wherein the controller is further configured to:
determine an actuation parameter for an actuator of the motor vehicle;
control the actuator for at least partially engaging the clutch with the control device as a function of the distance parameter and the actuation parameter.

26. The control device according to claim 24, wherein the controller is further configured to:
determine an operating mode of the vehicle; and
control the actuator for at least partially engaging the clutch with the control device as a function of the distance parameter and the operating mode.

27. The control device according to claim 24, wherein the operating mode is selected from the group consisting of a driving start mode or a parking mode.

28. The control device according to claim 24, wherein the controller is further configured to compute the distance parameter from a sensed distance between the motor vehicle and an object in an environment around the motor vehicle.

29. A motor vehicle comprising:
a drive unit;
at least one driven wheel;
a clutch selectively coupling the drive unit and the driven wheel; and
a control device including an actuator and a controller actuating the clutch to selectively couple the drive unit and the driven wheel, wherein the controller is configured to:
determine a distance parameter for the motor vehicle, wherein the distance parameter is selected from a group of parameters consisting of a distance between the motor vehicle and an object in an environment of the motor vehicle, a change in the distance, a first time derivative of the change in the distance, a second time derivative of the change in the distance or a combination thereof;
determine a clutch torque curve as a function of the distance parameter; and
control the actuator for at least partially engaging the clutch according to the clutch torque curve.

30. The motor vehicle according to claim 29, wherein the clutch is arranged between the drive unit and a shift gearbox operative coupled to the at least one driven wheel.

31. The motor vehicle according to claim 29, wherein the shift gearbox is selected from the group consisting of an at least partially automatic shift gearbox, an at least partially or manual shift gearbox, a dual-clutch gearbox, or an electrically-actuated shift gearbox.
